(19) United States
(12) Patent Application Publication
(10) Pub. No.: US 2026/0045060 A1
(43) Pub. Date: Feb. 12, 2026

(54) Spatiotemporal Representations of a Physical Environment

(71) Applicant: Apple Inc., Cupertino, CA (US)

(72) Inventors: Gowri Somanath, San Jose, CA (US); Daniel Ulbricht, Sunnyvale, CA (US)

(21) Appl. No.: 19/286,524

(22) Filed: Jul. 31, 2025

Related U.S. Application Data
(60) Provisional application No. 63/680,842, filed on Aug. 8, 2024.

(51) Int. Cl. G06V 10/25; G06V 10/62; G06V 10/75; G06V 20/50

(52) U.S. Cl. CPC G06V 10/25; G06V 10/62; G06V 10/759; G06V 20/50

(57) ABSTRACT

A method is performed at an electronic device with one or more processors and a non-transitory memory. The method includes obtaining a plurality of volumetric regions of a physical environment based on a first representation of the physical environment at a first time. Each of the plurality of volumetric regions includes a corresponding portion of the physical environment. The method includes determining a first feature property based on a query. The method includes identifying a first volumetric region of the first plurality of volumetric regions based on determining that the first volumetric region satisfies a criterion with respect to the first feature property.

### CROSS-REFERENCE TO RELATED APPLICATIONS

This application claims priority to U.S. Provisional Patent App. No. 63/680,842, filed on Aug. 8, 2024, which is hereby incorporated by reference in its entirety.

### TECHNICAL FIELD

The present disclosure relates to scene understanding of a physical environment.

### BACKGROUND

Various scene understanding techniques exist to understand features of a physical environment. However, these techniques have various limitations regarding the accuracy and efficiency of the scene understanding.

### SUMMARY

A method is performed at an electronic device with one or more processors and a non-transitory memory. The method includes obtaining a plurality of volumetric regions of a physical environment based on a first representation of the physical environment at a first time. Each of the plurality of volumetric regions includes a corresponding portion of the physical environment. The method includes determining a first feature property based on a query. The method includes identifying a first volumetric region of the first plurality of volumetric regions based on determining that the first volumetric region satisfies a criterion with respect to the first feature property.

In accordance with some implementations, an electronic device includes one or more processors and a non-transitory memory. One or more programs are stored in the non-transitory memory and are configured to be executed by the one or more processors. The one or more programs include instructions for performing or causing performance of the operations of any of the methods described herein. In accordance with some implementations, a non-transitory computer readable storage medium has stored therein instructions which when executed by one or more processors of an electronic device, cause the electronic device to perform or cause performance of the operations of any of the methods described herein. In accordance with some implementations, an electronic device includes means for performing or causing performance of the operations of any of the methods described herein. In accordance with some implementations, an information processing apparatus, for use in an electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIGS. 1A-1H are examples of an operating environment in accordance with some implementations.

FIG. 2 is an example of a block diagram of a portable multifunction device in accordance with some implementations.

FIG. 3A is an example of a first spatiotemporal characteristic vector in accordance with some implementations.

FIG. 3B is an example of a second spatiotemporal characteristic vector in accordance with some implementations.

FIG. 4 is an example of a flow diagram of a method of identifying a volumetric region of a physical environment based on a feature property in accordance with some implementations.

FIG. 5 is an example of a flow diagram of a method of generating and updating a spatiotemporal characteristic vector associated with a physical environment at different times in accordance with some implementations.

### DESCRIPTION OF IMPLEMENTATIONS

Some scene understanding techniques include generating a 3D mesh of a physical environment or keyframes projected onto 2D images of the physical environment. These techniques have various limitations. For example, these techniques cannot accurately account for volumetric regions of a physical environment, and especially struggle in accounting for empty space of the physical environment. Additionally, these techniques cannot effectively account for changes to features of a physical environment over time, as these techniques provide a single snapshot of the physical environment. Moreover, keyframes are dependent on the extent to which an image sensor effectively scans a physical environment, and thus the effectiveness of using keyframes may be limited by user control of the scanning.

By contrast, various implementations disclosed herein include methods, electronic devices, and systems for assessing a plurality of volumetric regions of a physical environment, to identify a suitable volumetric region based on a query. For example, a query indicates a specific user activity, and a method includes identifying a volumetric region that is a suitable size for performing the user activity. In some implementations, identifying a volumetric region is also based on a characteristic associated with the volumetric region. For example, a method includes determining that a volumetric region is characterized by high luminance levels at a particular time of day, and determining the volumetric region is suitable for a user activity because at least a medium luminance level is needed to perform the user activity successfully.

In some implementations, methods, electronic devices, and systems include generating and updating a spatiotemporal characteristic vector based on representations of a physical environment at different times. For example, a method includes generating a spatiotemporal characteristic vector that indicates the physical environment is characterized by a first plurality of volumetric regions at a first time. For example, the first plurality of volumetric regions includes spatial information regarding a physical chair, empty space, and a physical wall. Continuing with this example, the method includes updating the spatiotemporal characteristic vector to indicate the physical environment is characterized by a second plurality of volumetric regions at a second time. For example, the second plurality of volumetric regions includes spatial information regarding expanded empty space (compared with the empty space the first time) and the physical wall, because the physical chair is not present in the physical environment at the second time. Thus, in contrast to other techniques, a spatiotemporal characteristic vector provides a volumetric characterization (e.g., description) of a physical environment across multiple point in time, and may include respective characterizations of empty space and a physical object (at the same time or at different times).

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

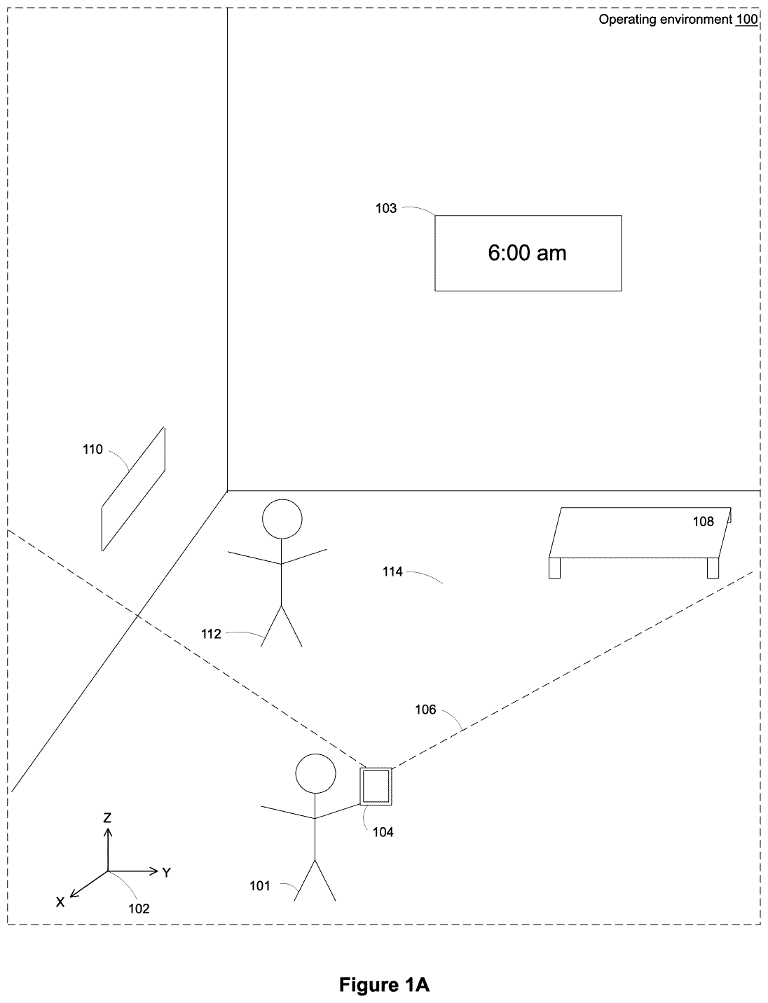

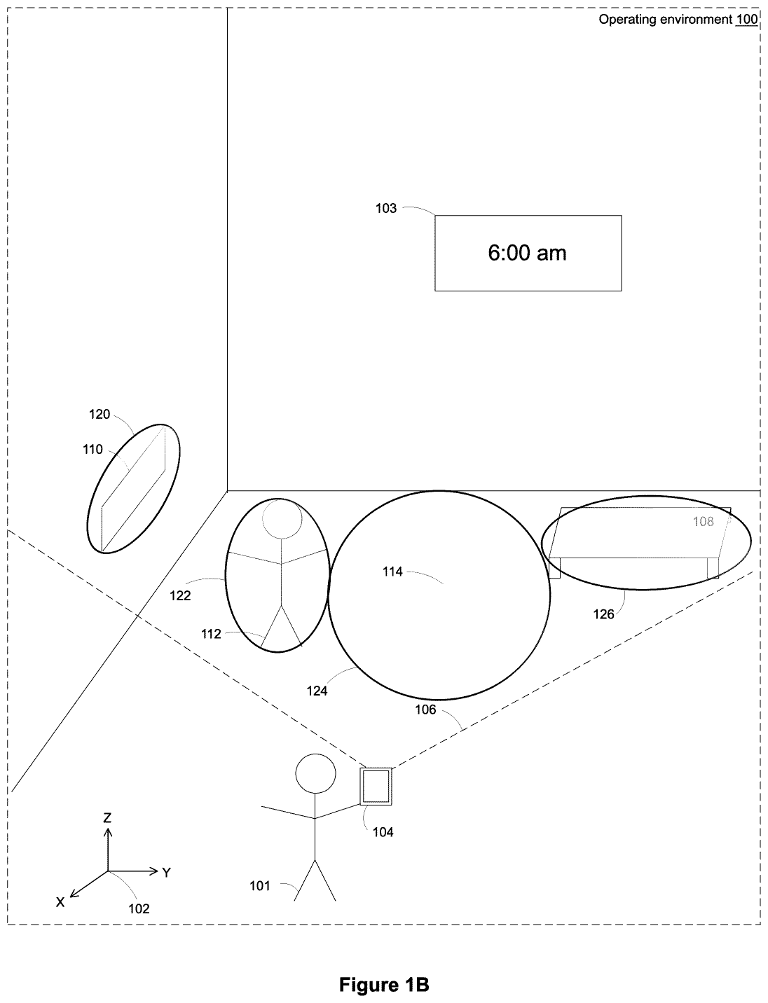

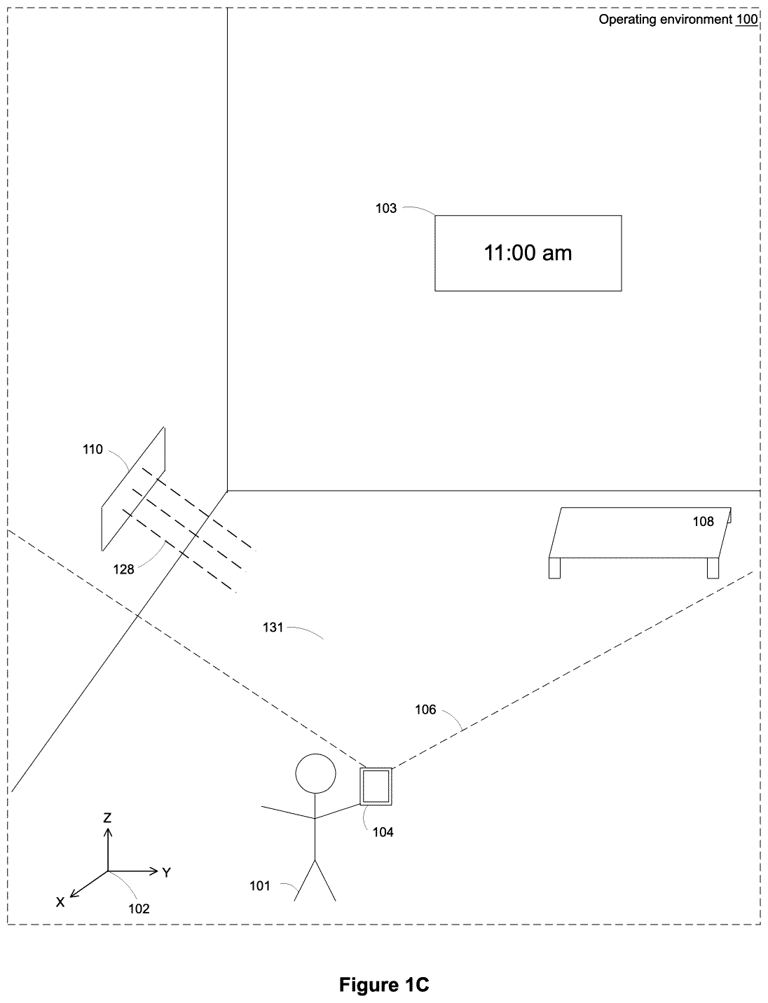

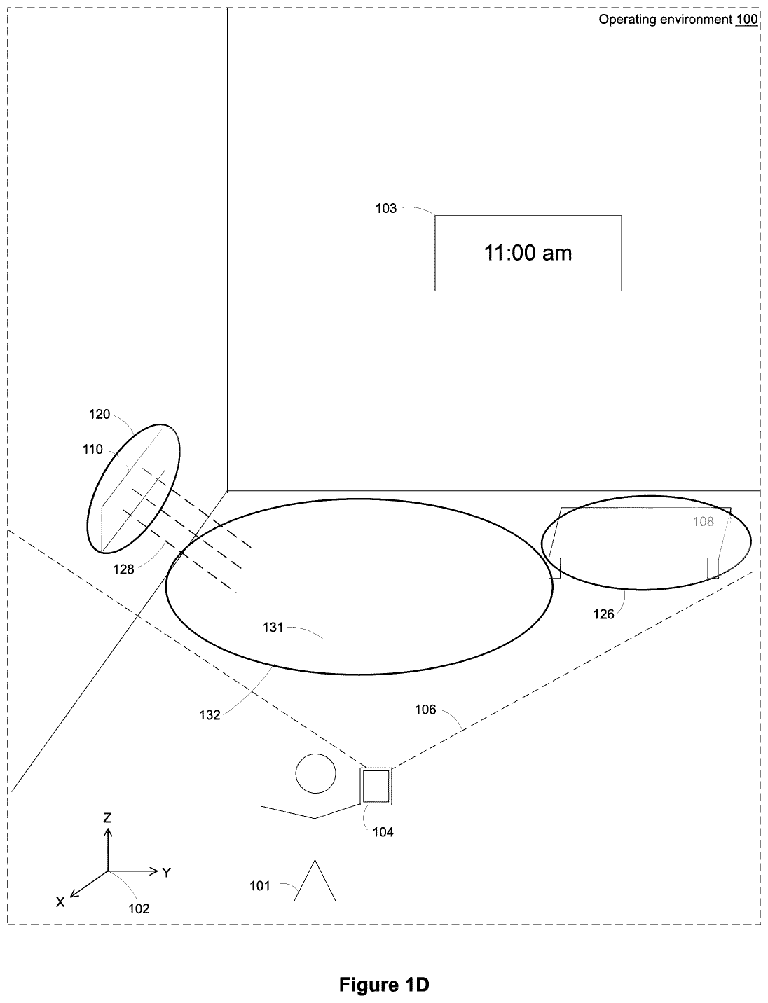

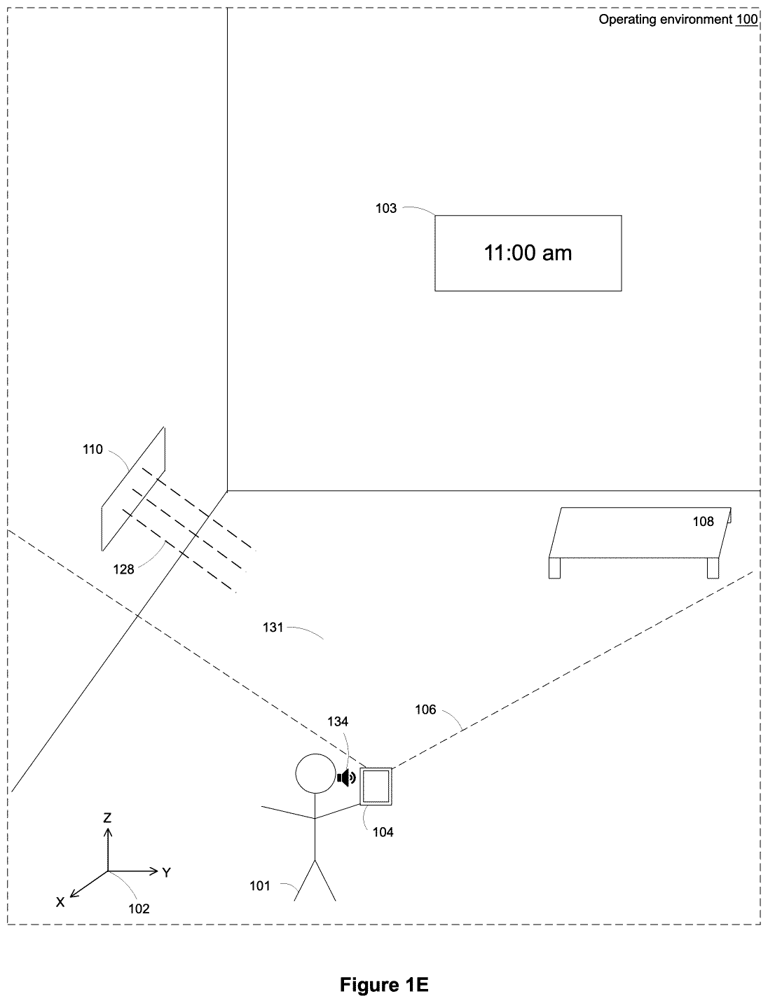

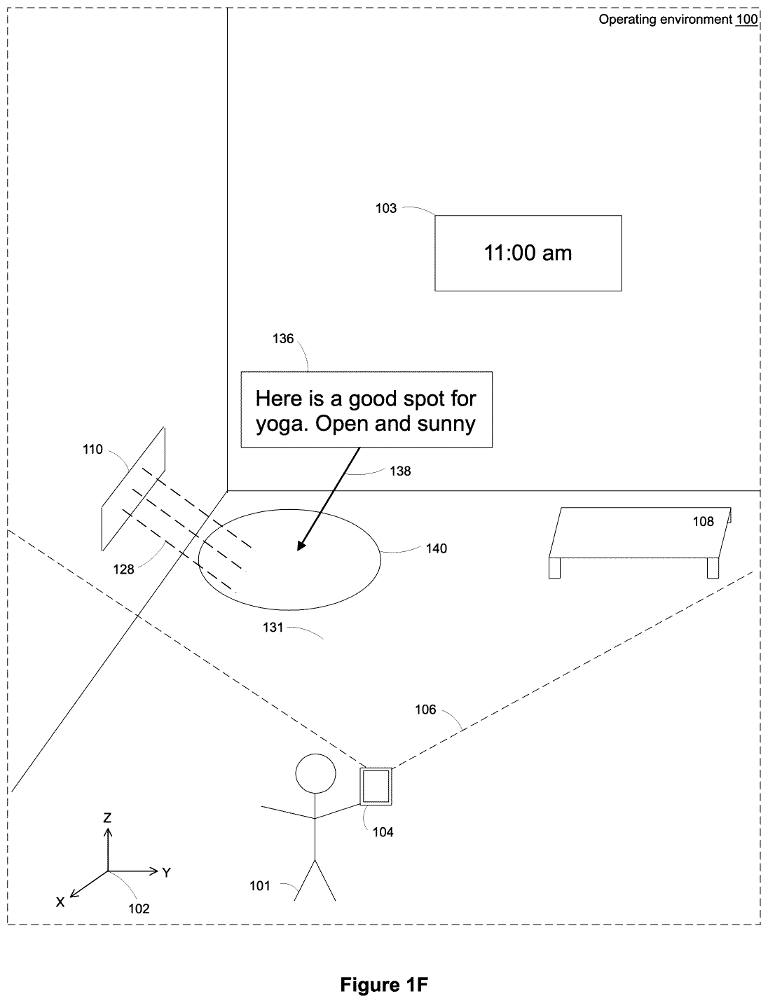

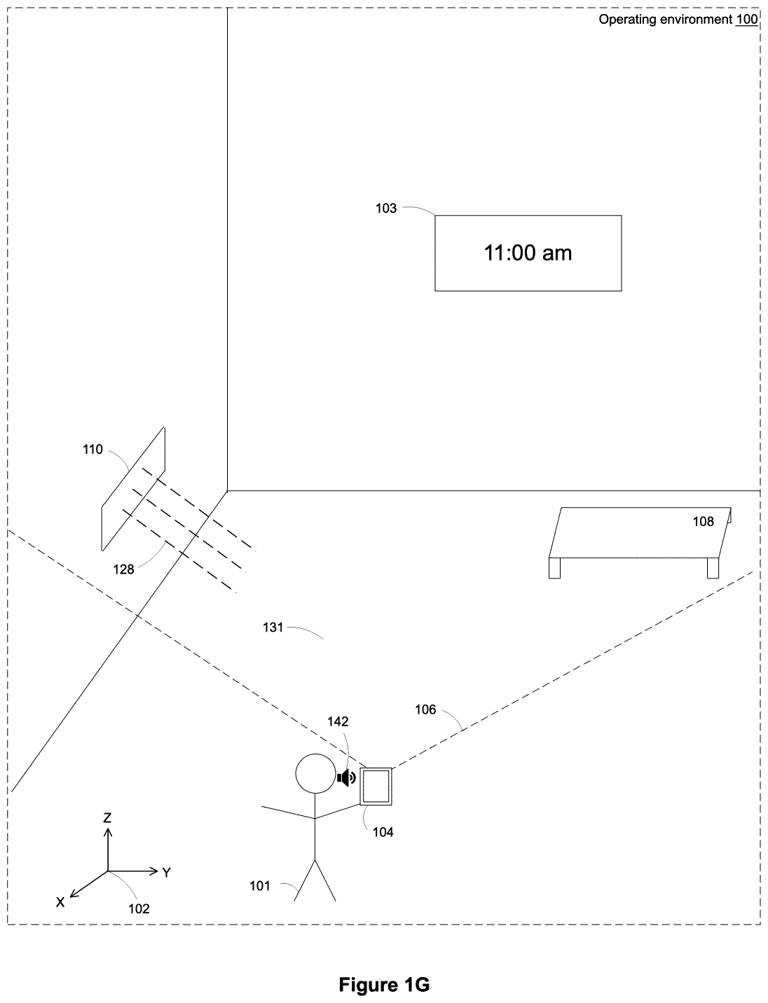

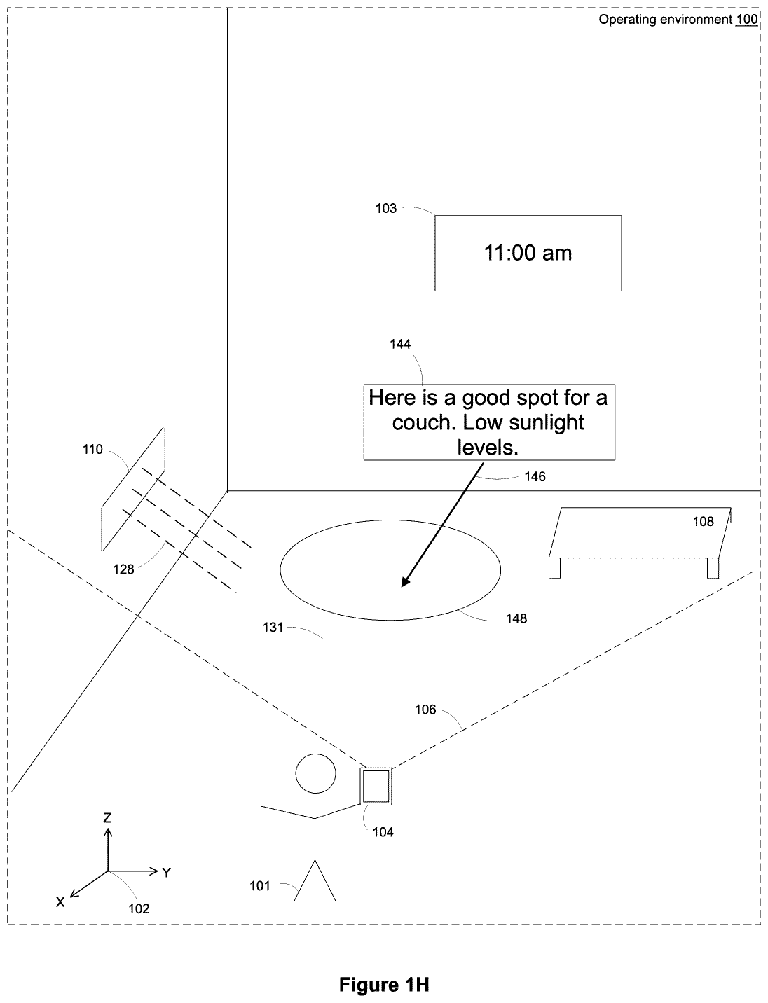

FIGS. 1A-1H are examples of an operating environment 100 in accordance with some implementations. As will be described below, the operating environment 100 is a three-dimensional (3D) (e.g., volumetric) environment defined by 3D coordinates 102. The 3D coordinates 102 includes x coordinates, y coordinates, and z coordinates. One of ordinary skill in the art will appreciate that the operating environment 100 may be defined be any type of 3D coordinate system.

As illustrated in FIG. 1A, the operating environment 100 includes a user 101 holding an electronic device 104, such as a tablet, mobile phone, laptop, wearable computing device, or the like. The operating environment 100 includes a virtual clock 103 that is world-locked to an anchor point of the back wall of the operating environment 100. The virtual clock 103 shows that the current time of day is “6:00 am.” The operating environment 100 includes a physical window 110 that is attached to the side wall of the operating environment 100. The operating environment 100 also includes an individual 112, a physical table 108, and empty space 114 between the individual 112 and the physical table 108.

With reference to the 3D coordinates 102, the physical window 110 has a relatively low y value because it is located near the left edge of the operating environment 100. The individual 112 has a medium y value, and a relatively high x value because the individual 112 is near to the electronic device 104 (e.g., low depth). The physical table 108 has a relatively high y value because it is located near the right edge of the operating environment 100. The anchor point of the back wall (to which the virtual clock 103 is world-locked) has a relatively low x value because the anchor point is far from the electronic device 104 (e.g., high depth).

In some implementations, the operating environment 100 corresponds to an XR environment, including physical object(s) and computer-generated object(s). To that end, the electronic device 104 is configured to manage and coordinate an XR experience via a display of the electronic device 104. For example, the electronic device 104 includes a viewable region 106, and the viewable region includes the anchor point of the back wall, the physical window 110, the individual 112, the empty space 114, and the physical table 108. Continuing with this example, the electronic device 104 includes an image sensor that captures image data including the physical window 110, the individual 112, the empty space 114, and the physical table 108. Continuing with this example, the electronic device 104 composites the image data with the virtual clock 103, and displays the composited data on the display of the electronic device 104 to present an XR experience.

In some implementations, the electronic device 104 corresponds to a head-mountable device (HMD) that includes an integrated display (e.g., a built-in display) that displays a representation of the operating environment 100. In some implementations, the electronic device 104 includes a head-mountable enclosure. In various implementations, the head-mountable enclosure includes an attachment region to which another device with a display can be attached. In various implementations, the head-mountable enclosure is shaped to form a receptacle for receiving another device that includes a display (e.g., the electronic device 104). For example, in some implementations, the electronic device 104 slides/snaps into or otherwise attaches to the head-mountable enclosure. In some implementations, the display of the device attached to the head-mountable enclosure presents (e.g., displays) the representation of the operating environment 100. For example, in some implementations, the electronic device 104 corresponds to a mobile phone that can be attached to the head-mountable enclosure.

In various implementations, the electronic device 104 obtains a first plurality of volumetric regions of a physical environment, based on a first representation of the physical environment at a first time. The first representation of the physical environment may be a 3D reconstruction (e.g., 3D mesh) of the physical environment, or may be a set of keyframes projected onto two dimensional (2D) images of the physical environment.

For example, with reference to FIG. 1B, the electronic device 104 obtains a first volumetric region 120 including the physical window 110, a second volumetric region 122 including the individual 112, a third volumetric region 124 including the empty space 114, and a fourth volumetric region 126 including the physical table 108. In some implementations, the electronic device 104 performs semantic segmentation with respect to a 3D reconstruction of the physical environment, in order to determine semantic values for each of the volumetric regions.

In some implementations, each of the first plurality of volumetric regions defines a corresponding portion of the physical environment. For example, the first volumetric region 120 indicates a set of XYZ coordinates that approximately bound the physical window 110. For example, a volumetric region is defined to have volumetric dimensions that fit around the edges of a corresponding physical object. In some implementations, the volumetric dimensions that fit around the edges of a corresponding physical object

In some implementations, a volumetric region corresponds to an empty (e.g., vacant) space of a physical environment. For example, an empty space is a region of a physical environment that does not include a physical object. In some implementations, an empty space does not include a physical object, but may include a physical bounding surface of a physical environment, such as a wall or the floor. For example, with reference to FIG. 1B, the third volumetric region 124 includes the empty space 114.

As another example, a volumetric region corresponds to a predefined volumetric shape type (e.g., sphere or cube) that spatially includes a physical object and region(s) of the physical environment that are adjacent to the physical object. Continuing with the previous example, the size of the adjacent region(s) may be a function of the type of predefined volumetric shape type relative to the physical object—e.g., a predefined sphere closely maps to a physical basketball (small adjacent regions), whereas the predefined sphere does not as closely map to physical table (larger adjacent regions). In some implementations, each of the first plurality of volumetric regions defines a distinct portion of the physical environment.

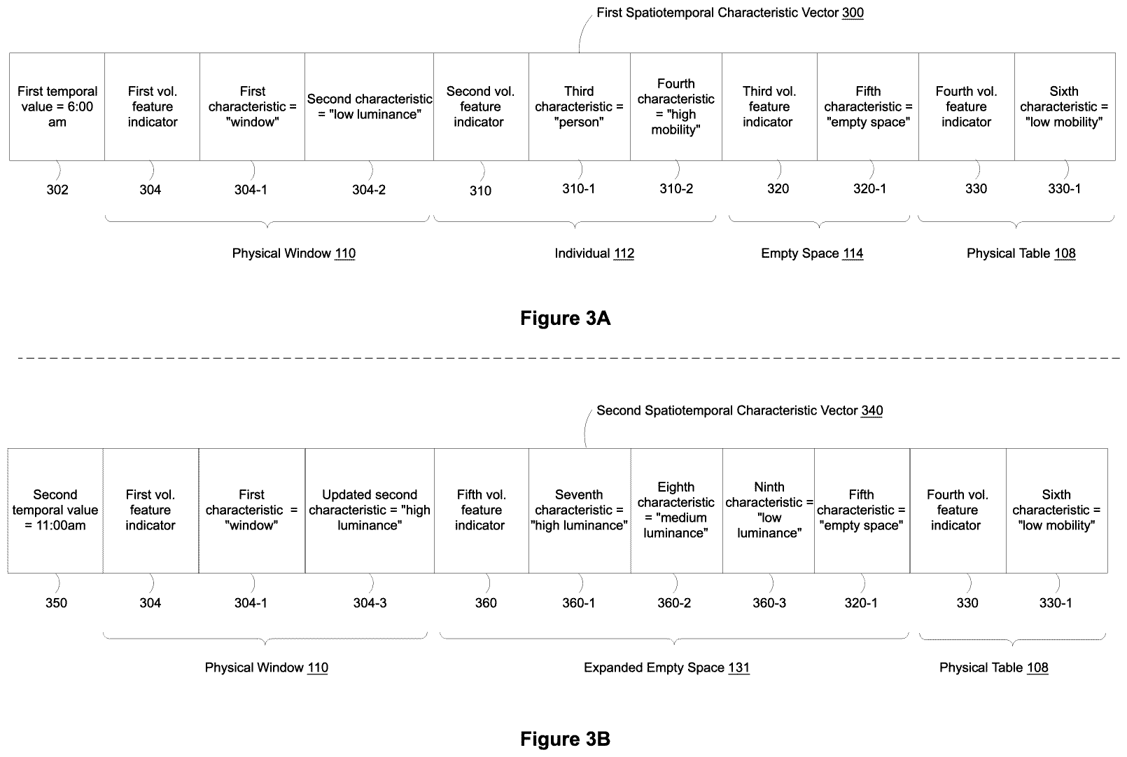

In some implementations and with reference to FIG. 3A, the electronic device 104 generates a first spatiotemporal characteristic vector 300 based on the first representation of the physical environment at the first time. The first spatiotemporal characteristic vector 300 may include characteristics for some or all of the first plurality of volumetric regions. The first spatiotemporal characteristic vector 300 is associated with the first time of 6:00 am, and thus the first spatiotemporal characteristic vector 300 includes a first temporal value 302 indicating the first time of “6:00 am.”

The first spatiotemporal characteristic vector 300 includes a first volumetric region indicator 304 associated with the first volumetric region 120 (including the physical window 110). For example, the first volumetric region indicator 304 indicates the XYZ position of the physical window 110 in 3D space. In some implementations, the first volumetric region indicator 304 indicates a volume of the physical window 110. The first spatiotemporal characteristic vector 300 includes a first characteristic 304-1 (associated with the physical window 110) indicating a “window.” To that end, in some implementations, the electronic device 104 performs semantic segmentation on captured image data to identify a subset of pixels of the image data corresponding to a window. The first spatiotemporal characteristic vector 300 includes a second characteristic 304-2 indicating a “low luminance” associated with the physical window 110, because there is a nominal amount of sunlight entering the physical window 110 at 6:00 am.

The first spatiotemporal characteristic vector 300 includes a second volumetric region indicator 310 associated with the second volumetric region 122 (including the individual 112). For example, the second volumetric region indicator 310 indicates the XYZ position of the individual 112 in 3D space. In some implementations, the second volumetric region indicator 310 indicates a volume of the individual 112. The first spatiotemporal characteristic vector 300 includes a third characteristic 310-1 (associated with the individual 112) indicating a “person.” To that end, in some implementations, the electronic device 104 performs semantic segmentation on captured image data to identify a subset of pixels of the image data corresponding to a person. The first spatiotemporal characteristic vector 300 includes a fourth characteristic 310-2 indicating a “high mobility” of the individual 112. Namely, the individual 112 is highly mobile—e.g., compared to furniture, such as the physical table 108.

The first spatiotemporal characteristic vector 300 includes a third volumetric region indicator 320 associated with the third volumetric region 124 (including the empty space 114). For example, the third volumetric region indicator 320 indicates the XYZ position of the empty space 114 in 3D space. In some implementations, the third volumetric region indicator 320 indicates a volume of the empty space 114. The first spatiotemporal characteristic vector 300 includes a fifth characteristic 320-1 indicating “empty space.” To that end, in some implementations, the electronic device 104 performs semantic segmentation on captured image data to identify a subset of pixels of the image data corresponding to the empty space 114.

The first spatiotemporal characteristic vector 300 includes a fourth volumetric region indicator 330 associated with the fourth volumetric region 124 (including the physical table 108). For example, the fourth volumetric region indicator 330 indicates the XYZ position of the physical table 108 in 3D space. In some implementations, the fourth volumetric region indicator 330 indicates a volume of the physical table 108. The first spatiotemporal characteristic vector 300 includes a sixth characteristic 330-1 indicating “low mobility” of the physical table 108. To that end, in some implementations, the electronic device 104 performs semantic segmentation on captured image data to identify the physical table 108 within the captured data, and identifies that the physical table 108 has low mobility (e.g., as compared with the individual 112).

FIG. 1C illustrates the operating environment 100 at a second time of 11:00 am, as indicated by the virtual clock 103. FIG. 1C illustrates the operating environment 100 at 11:00 am, which is nearer to the middle of the day than 6:00 am (illustrated in FIGS. 1A and 1B), and thus light from the sun enters the physical window 110, as indicated by sun rays 128 in FIG. 1C. Additionally, the individual 112 is no longer within the operating environment 100 at the second time.

In various implementations, the electronic device 104 obtains a second plurality of volumetric regions of the physical environment based on a second representation of the physical environment at the second time. For example, with reference to FIG. 1D, the electronic device 104 obtains the first volumetric region 120 including the physical window 110, the fourth volumetric region 126 including the physical table 108, and a fifth volumetric region 132 including an expanded empty space 131, as compared with the empty space 114 illustrated in FIG. 1B. The expanded empty space 131 corresponds to a portion of the operating environment 100 between the side wall (which includes the physical window 110) and the physical table 108.

In some implementations and with reference to FIG. 3B, the electronic device 104 determines a second spatiotemporal characteristic vector 340, based on the second representation of the physical environment at the second time. The second spatiotemporal characteristic vector 340 includes a second temporal value 350 indicating the second time of “11:00 am.” In some implementations, the second spatiotemporal characteristic vector 340 is an updated version of the first spatiotemporal characteristic vector 300.

Because the position of the physical window 110 has not changed from the first time to the second time, the second spatiotemporal characteristic vector 340 includes the first volumetric region indicator 304, indicating the same position of the physical window 110 in 3D space, and includes the first characteristic 304-1 indicating a “window.” However, because the sun rays 128 are now entering the physical window 110, the electronic device 104 determines an updated second characteristic 304-3, indicating “high luminance” for the physical window 110.

Additionally, in some implementations, as part of determining the second spatiotemporal characteristic vector 340, the electronic device 104 removes from the first spatiotemporal characteristic vector 300 portions related to the individual 112, because the individual 112 is no longer within the operating environment 100. For example, with reference to FIG. 3B, the second spatiotemporal characteristic vector 340 ceases to include the second volumetric region indicator 310, the third characteristic 310-1, and the fourth characteristic 310-2, each of which was associated with the individual 112.

To account for the expanded empty space 131 illustrated in FIG. 1D (as compared with FIG. 1B), the electronic device 104 determines, for the second spatiotemporal characteristic vector 340, a fifth volume indicator 360 associated with the expanded empty space 131. For example, the fifth volumetric region indicator 360 indicates the XYZ position of the expanded empty space 131 in 3D space. In some implementations, the fifth volumetric region indicator 360 indicates a volume of the expanded empty space 131. In some implementations, the second spatiotemporal characteristic vector 340 includes a plurality of characteristics associated with the expanded empty space 131, each of which may characterize a distinct portion of the expanded empty space 131. For example, the second spatiotemporal characteristic vector 340 includes a seventh characteristic 360-1 that indicates that the left portion of the expanded empty space 131 near the sun rays 128 (e.g., relatively low y value) has a correspondingly “high luminance.” Continuing with this example, the second spatiotemporal characteristic vector 340 includes an eighth characteristic 360-2 that indicates that the middle portion of the expanded empty space 131 that is farther from the sun rays (e.g., medium y value) has a correspondingly “medium luminance.” Continuing with this example, the second spatiotemporal characteristic vector 340 includes a ninth characteristic 360-3 that indicates that the right portion of the expanded empty space 131, which is even farther from the sun rays (e.g., high y value), has a correspondingly “low luminance.” In some implementations, the electronic device 104 separates a region into multiple sub-regions, and determines a characteristic for each of sub-region. For example, in some implementations, the electronic device 104 separates the expanded empty space 131 into a first sub-region corresponding to the left portion of the region, a second sub-region corresponding to the middle portion of the region, and a third sub-region corresponding to the right portion of the region. Continuing with this example, the electronic device 104 may associate the seventh characteristic 360-1 with the first sub-region, the eighth characteristic 360-2 with the second sub-region, and the ninth characteristic 360-3 with the third sub-region.

Because the position of the physical table 108 has not changed from the first time to the second time, the second spatiotemporal characteristic vector 340 includes the fourth volumetric region indicator 330, indicating the same position of the physical table 108 in 3D space, and includes the includes the sixth characteristic 330-1 indicating a “low mobility” for the physical table 108.

In some implementations, a spatiotemporal characteristic vector is represented by one or more spherical gaussians. Each spherical gaussian may define respective relationships between a plurality of characteristics and corresponding portions of a volumetric region in 3D space. For example, with reference to FIGS. 1D and 3B, a spherical gaussian associates the left portion of the expanded empty space 131 with high luminance, associates the middle portion of the expanded empty space 131 with medium luminance, and associates the right portion of the expanded empty space 131 with low luminance.

As illustrated in FIG. 1E, the electronic device 104 detects a first query corresponding to a first utterance 134 of the user 101, wherein the first utterance 134 is “where is a good place to do yoga?” The text of the first utterance 134 is not depicted in FIG. 1E for the sake of clarity. To that end, in some implementations, the electronic device 104 includes an audio sensor (e.g., microphone) that detects the first utterance 134, and the electronic device 104 converts the first utterance 134 to audio data. A query may correspond to any type of input from the user 101. For example, a query may be a touch input that the user 101 directs to the electronic device 104 (e.g., text input to a chatbot application executing on the electronic device 104). As another example, a query may be a gaze input directed from an eye of the user 101 to a portion of the operating environment 100.

In various implementations, the electronic device 104 determines a first feature property based on the first query. For example, the first feature property is determined based on suitability for performing an activity indicated by the first query. For example, based on detecting the word “yoga” in the first utterance 134, the electronic device 104 determines that the first feature property is empty space of at least six feet by three feet, because this amount of empty space is suitable for practicing yoga. In various implementations, the electronic device 104 determines a second feature property based on the first query. Continuing with the previous example, based on detecting the word “yoga” in the first utterance 134, the electronic device 104 determines that the second feature property is at least a medium level of luminance, which is also suitable for practicing yoga. In some implementations, the electronic device 104 assesses multiple words in the first utterance 134 to determine the first feature property. For example, in addition to detecting the word “yoga,” the electronic device 104 detects “where is a good place,” and uses the combination of the “yoga” and “where is a good place” to determine that the user 101 wants to practice yoga, instead of that the user 101 wants to watch yoga, for example.

In various implementations, the electronic device 104 determines the first feature property based on the first query and additional contextual information. For example, the electronic device 104 may determine a property of the user 101, such as the height of the user 101 is six feet. Continuing with this example, the electronic device 104 determines the first feature property should include an empty space length of at least six feet. Additional examples of contextual information include an age of the user 101, a hobby list of the user 101, etc. For example, if the hobby list includes “yoga,” the electronic device 104 determines, with a higher degree of confidence, that the word “yoga” in the first utterance 134 indicates the user 101 wants to practice yoga.

In various implementations, the electronic device 104 identifies one or more volumetric region, of the second plurality of volumetric regions, based on determining that each of the volumetric region(s) satisfies a criterion with respect to the first feature property (and optionally with respect to the second (or more) feature property). For example, the electronic device 104 identifies the volumetric region(s) based on determining that the volumetric region(s) match the first feature property within an error threshold. Alternatively or additionally, the electronic device 104 assesses the second plurality of volumetric regions in view of the second feature property. Continuing with the previous example, the electronic device 104 assesses the first and second pluralities of volumetric regions (120, 122, 124, 126, and 132) to determine which include at least six feet by three feet of empty space and/or include at least a medium level of luminance. The electronic device 104 identifies, based on third volume feature indicator 320, that the third volumetric region 124 including the empty space 114 in FIG. 1B includes at least the six feet by three feet of empty space. Moreover, the electronic device 104 identifies, based on the fifth volume feature indicator 360, that the fifth volumetric region 132 including the expanded empty space 131 in FIG. 1D also includes at least the six feet by three feet of empty space. Thus, in some implementations, the electronic device 104 determines that each of the third volumetric region 124 and the fifth volumetric region 132 matches the first feature property within the error threshold. Accordingly, the electronic device 104 identifies the third volumetric region 124 and the fifth volumetric region 132. Assessing regions of the operating environment 100 at different times may enable the electronic device 104 to identify a first feature property with greater confidence, as compared with assessing a single region at a single point in time. Referring back to the previous example, the electronic device 104 may identify, with high confidence, a sub-region that is common to both the third volumetric region 124 and the fifth volumetric region 132.

In some implementations, because the first spatiotemporal characteristic vector 300 does not include a luminance characteristic associated with the third volumetric region 124, the electronic device 104 determines that the third volumetric region 124 does not match the second feature property within the error threshold, and thus does not identify the third volumetric region 124. On the other hand, the second spatiotemporal characteristic vector 340 includes three luminance characteristics associated with the fifth volumetric region 132. Namely, the second spatiotemporal characteristic vector 340 includes the seventh characteristic 360-1 indicating the left portion of the expanded empty space 131 has “high luminance,” the eighth characteristic 360-2 indicating that the middle portion of the expanded empty space 131 has “medium luminance,” and the ninth characteristic 360-3 indicating the right portion of the expanded empty space 131 has “low luminance.” Because the second property feature is at least a medium luminance, the electronic device 104 determines each of the left portion of the expanded empty space 131 (“high luminance)” and middle portion of the expanded empty space 131 (“medium luminance)” satisfies the second feature property within the error threshold. Thus, in some implementations, the electronic device 104 identifies the left and middle portions of the fifth volumetric region 132, but not the right portion of the fifth volumetric region 132.

In some implementations, the electronic device 104 presents, on a display, an indicator at a location corresponding to an identified volumetric region. The indicator may include information regarding the first query. Continuing with the previous example and with reference to FIG. 1F, the electronic device 104 presents, on a display, a first indicator indicating the identified left and middle portions of fifth volumetric region 132. In some implementations, the first indicator is world-locked to the left and/or middle portions of the expanded empty space 131. The first indicator includes text 136 indicating “Here is a good spot for yoga. Open and sunny.” The first indicator includes an arrow 138 leading from the text 136 to an ovular location indicator 140 indicating a location in which it is suitable to practice yoga.

Although not depicted in FIG. 1F, in some implementations, the first indicator includes temporal information. For example, because the first spatiotemporal characteristic vector 300 associated with the first time of 6:00 am does not include a matching volumetric region, but the second spatiotemporal characteristic vector 340 associated with the second time of 11:00 am includes a matching volumetric region, the text 136 may include the second temporal value of “11:00 am.” For example, the text 136 may correspond to “This is a good spot for yoga around 11:00 am.”

As illustrated in FIG. 1G, the electronic device 104 detects a second query corresponding to a second utterance 142 of the user 101, wherein the second utterance 142 is “where is a good place to put a couch that is not too sunny?” The text of the second utterance 142 is not depicted in FIG. 1G for the sake of clarity.

Because the second utterance 142 requests “a place to put a couch,” the electronic device 104 determines a third feature property corresponding to empty space at least large enough to fit an average couch. Accordingly, the electronic device 104 determines, based on the third volumetric region indicator 320, that the third volumetric region 124 including the empty space 114 is not large enough to fit the average couch. Thus, the third volumetric region 124 does not match the third feature property within the error threshold. On the other hand, the electronic device 104 determines, based on the fifth volumetric region indicator 360, that the fifth volumetric region 132 including the expanded empty space 131 is large enough to fit the average couch. Thus, the fifth volumetric region 132 matches the third feature property within the error threshold.

In some implementations, the electronic device 104 determines, based on the second utterance 142, a fourth feature property corresponding to less than a threshold luminance level. Thus, in some implementations, the electronic device 104 identifies a portion of the fifth volumetric region 132 that is associated with the ninth characteristic 360-3 of “low luminance.” Namely, the electronic device 104 determines a portion of the expanded empty space 131 that is sufficiently far from the sun rays 128. Accordingly, as illustrated in FIG. 1H, in some implementations the electronic device 104 presents a second indicator that indicates the portion of the expanded empty space 131 that is sufficiently far from the sun rays 128. In some implementations, the second indicator is world-locked to this portion of the expanded empty space 131. The second indicator includes text 144 indicating “Here is a good spot for a couch. Low sunlight levels.” The second indicator includes an arrow 146 leading from the text 144 to an ovular location indicator 148 indicating a location where it is suitable to place a couch.

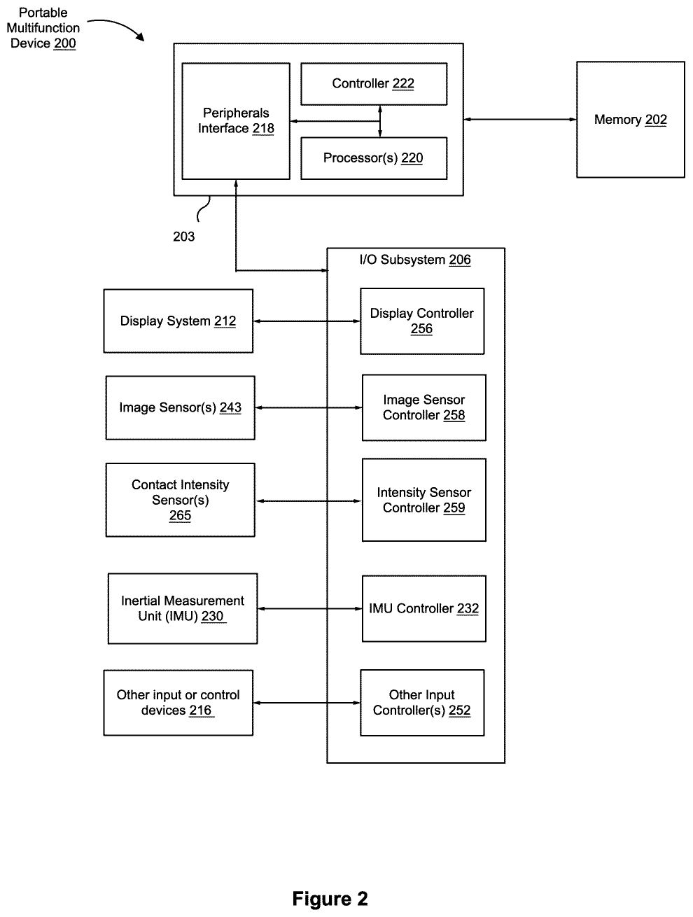

FIG. 2 is a block diagram of an example of a portable multifunction device 200 (sometimes also referred to herein as the “electronic device 200” for the sake of brevity) in accordance with some implementations. In some implementations, the electronic device 200 corresponds to the electronic device 104 described with reference to FIGS. 1A-1H.

The electronic device 200 includes a memory 202 (e.g., a non-transitory computer readable storage medium), a memory controller 222, one or more processing units (CPUs) 220, a peripherals interface 218, an input/output (I/O) subsystem 206, a display system 212, an inertial measurement unit (IMU) 230, image sensor(s) 243 (e.g., camera), contact intensity sensor(s) 265, and other input or control device(s) 216. In some implementations, the electronic device 200 corresponds to one of a mobile phone, tablet, laptop, wearable computing device, head-mountable device (HMD), head-mountable enclosure (e.g., the electronic device 200 slides into or otherwise attaches to a head-mountable enclosure), or the like. In some implementations, the head-mountable enclosure is shaped to form a receptacle for receiving the electronic device 200 with a display.

In some implementations, the peripherals interface 218, the one or more processing units 220, and the memory controller 222 are, optionally, implemented on a single chip, such as a chip 203. In some other implementations, they are, optionally, implemented on separate chips.

The I/O subsystem 206 couples input/output peripherals on the electronic device 200, such as the display system 212 and the other input or control devices 216, with the peripherals interface 218. The I/O subsystem 206 optionally includes a display controller 256, an image sensor controller 258, an intensity sensor controller 259, one or more input controllers 252 for other input or control devices, and an IMU controller 232, The one or more input controllers 252 receive/send electrical signals from/to the other input or control devices 216. One example of the other input or control devices 216 is an eye tracker that tracks an eye gaze of a user. Another example of the other input or control devices 216 is an extremity tracker that tracks an extremity (e.g., a finger) of a user. In some implementations, the one or more input controllers 252 are, optionally, coupled with any (or none) of the following: a keyboard, infrared port, Universal Serial Bus (USB) port, stylus, finger-wearable device, and/or a pointer device such as a mouse. The one or more buttons optionally include a push button. In some implementations, the other input or control devices 216 includes a positional system (e.g., GPS) that obtains information concerning the location and/or orientation of the electronic device 200 relative to a particular object. In some implementations, the other input or control devices 216 include a depth sensor and/or a time-of-flight sensor that obtains depth information characterizing a physical object within a physical environment. In some implementations, the other input or control devices 216 include an ambient light sensor that senses ambient light from a physical environment and outputs corresponding ambient light data.

The display system 212 provides an input interface and an output interface between the electronic device 200 and a user. The display controller 256 receives and/or sends electrical signals from/to the display system 212. The display system 212 displays visual output to the user. The visual output optionally includes graphics, text, icons, video, and any combination thereof (sometimes referred to herein as “computer-generated content”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 212 may have a touch-sensitive surface, sensor, or set of sensors that accepts input from the user based on haptic and/or tactile contact. The display system 212 and the display controller 256 (along with any associated modules and/or sets of instructions in the memory 202) detect contact (and any movement or breaking of the contact) on the display system 212 and converts the detected contact into interaction with user-interface objects (e.g., one or more soft keys, icons, web pages or images) that are displayed on the display system 212.

The display system 212 optionally uses LCD (liquid crystal display) technology, LPD (light emitting polymer display) technology, or LED (light emitting diode) technology, although other display technologies are used in other implementations. The display system 212 and the display controller 256 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 212.

The user optionally makes contact with the display system 212 using any suitable object or appendage, such as a stylus, a finger-wearable device, a finger, and so forth. In some implementations, the user interface is designed to work with finger-based contacts and gestures, which can be less precise than stylus-based input due to the larger area of contact of a finger on the touch screen. In some implementations, the electronic device 200 translates the rough finger-based input into a precise pointer/cursor position or command for performing the actions desired by the user.

The inertial measurement unit (IMU) 230 includes accelerometers, gyroscopes, and/or magnetometers in order to measure various forces, angular rates, and/or magnetic field information with respect to the electronic device 200. Accordingly, according to various implementations, the IMU 230 detects one or more positional change inputs of the electronic device 200, such as the electronic device 200 being shaken, rotated, moved in a particular direction, and/or the like.

The image sensor(s) 243 capture still images and/or video. In some implementations, an image sensor 243 is located on the back of the electronic device 200, opposite a touch screen on the front of the electronic device 200, so that the touch screen is enabled for use as a viewfinder for still and/or video image acquisition. In some implementations, another image sensor 243 is located on the front of the electronic device 200 so that the user's image is obtained (e.g., for selfies, for videoconferencing while the user views the other video conference participants on the touch screen, etc.). In some implementations, the image sensor(s) are integrated within an HMD. For example, the image sensor(s) 243 output image data that represents a physical object (e.g., a physical agent) within a physical environment.

The contact intensity sensors 265 detect intensity of contacts on the electronic device 200 (e.g., a touch input on a touch-sensitive surface of the electronic device 200). The contact intensity sensors 265 are coupled with the intensity sensor controller 259 in the I/O subsystem 206. The contact intensity sensor(s) 265 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 265 receive contact intensity information (e.g., pressure information or a proxy for pressure information) from the physical environment. In some implementations, at least one contact intensity sensor 265 is collocated with, or proximate to, a touch-sensitive surface of the electronic device 200. In some implementations, at least one contact intensity sensor 265 is located on the side of the electronic device 200.

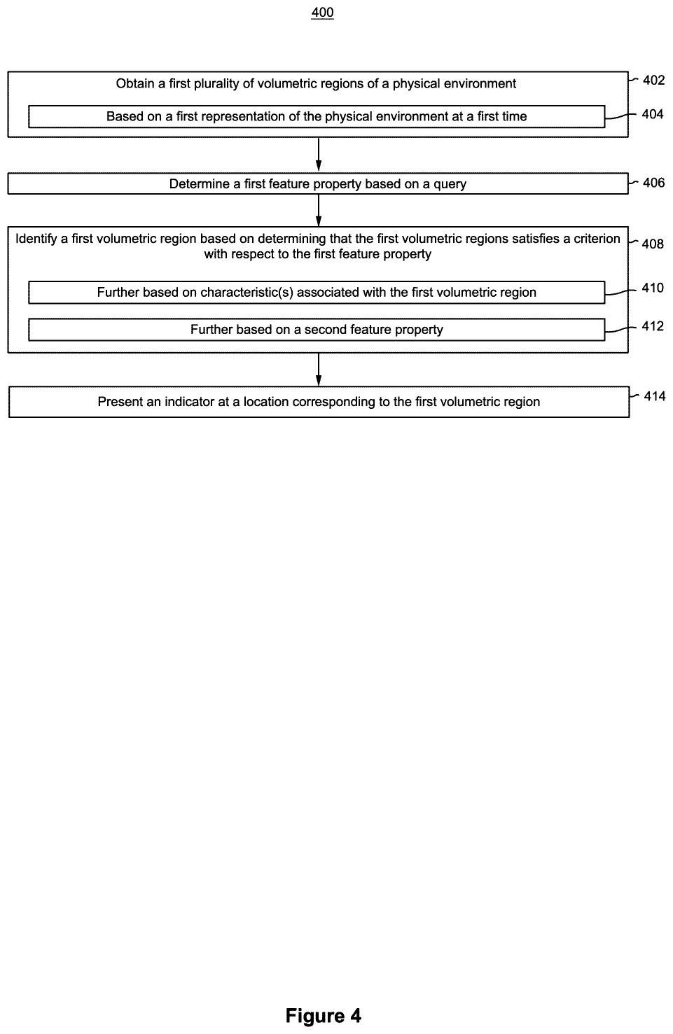

FIG. 4 is an example of a flow diagram of a method 400 of identifying a volumetric region of a physical environment based on a feature property in accordance with some implementations. In various implementations, the method 400 or portions thereof are performed by an electronic device including one or more processors and a non-transitory memory. For example, the electronic device 104 described with reference to FIGS. 1A-1H or the electronic device 200 described with reference to FIG. 2 performs the method 400. In various implementations, the method 400 or portions thereof are performed by a head-mountable device (HMD). In some implementations, the method 400 is performed by processing logic, including hardware, firmware, software, or a combination thereof. In some implementations, the method 400 is performed by a processor executing code stored in a non-transitory computer-readable medium (e.g., a memory). In various implementations, some operations in method 400 are, optionally, combined and/or the order of some operations is, optionally, changed.

As represented by block 402, the method 400 includes obtaining a first plurality of volumetric regions of a physical environment. As represented by block 404, the first plurality of volumetric regions is based on a first representation of the physical environment at a first time. Each of the first plurality of volumetric regions includes a corresponding portion of the physical environment. In some implementations, each of the first plurality of volumetric regions includes a distinct (e.g., non-overlapping in XYZ space) portion of the physical environment. For example, with reference to FIG. 1B, at 6:00 am, the electronic device 104 obtains a first plurality of distinct volumetric regions, including the first volumetric region 120 including the physical window 110, the second volumetric region 122 including the individual 112, the third volumetric region 124 including the empty space 114, and the fourth volumetric region 126 including the physical table 108. In some implementations, at least some of the first plurality of volumetric regions at least partially overlap with each other. For example, referring back to FIG. 1B, the third volumetric region 124 including the empty space 114 may be expanded to the left to be flush with the side wall of the operating environment 100. Accordingly, the expanded third volumetric region 124 partially overlaps with the second volumetric region 122 including the individual 112. The first representation of the physical environment may correspond to key frames of the physical environment, a 3D reconstruction of the physical environment, a 3D mesh of the physical environment, etc.

In some implementations, the method 400 includes determining the first representation based on environmental data of the physical environment, such as a scene understanding technique. To that end, the method 400 may include capturing the environmental data via an environmental sensor integrated in an electronic device performing the method 400. For example, the environmental sensor corresponds to an image sensor (e.g., camera), and the environmental data corresponds to image data of the physical environment. As another example, the environmental sensor corresponds to a depth sensor, and the environmental data corresponds to depth data regarding the physical environment. As yet another example, multiple environmental sensors may be used to determine the first representation.

In some implementations, an electronic device performing the method 400 obtains the first representation from another device. For example, the other device is a smart speaker that is disposed within the physical environment and includes environmental sensor(s) that capture environmental dataset(s) regarding the physical environment. To that end, in some implementations, the electronic device performing the method 400 is communicatively coupled (e.g., via Bluetooth) to the other device.

As represented by block 406, the method 400 includes determining a first feature property based on a query. For example, in some implementations, the query may correspond to a user query from a user, such as a voice input, touch input directed to an electronic device performing the method 400 (e.g., a user types the query), eye gaze of a user that is captured by the electronic device performing the method 400, etc. As one example, with reference to FIG. 1E, the query corresponds to the first utterance 134 of the user 101, wherein the first utterance 134 is “where is a good place to do yoga?” In some implementations, the query may correspond to an application query from an application. For example, a user opens a yoga app, and in turn the yoga app generates an application query querying an electronic device to assess an operating environment for a suitable place for the user to perform yoga.

In some implementations, the first feature property indicates a space size. For example, based on the first utterance 134 (“where is a good place to do yoga?”), the method 400 includes determining for the first feature property a space size of at least six feet by three feet is suitable for performing yoga. Thus, in some implementations, the first feature property is based on a type of user activity indicated in the query.

Other non-limiting examples of the first feature property include space type (e.g., empty space or space including a physical object), type of object in space (e.g., mobile object or non-mobile object), luminance level, type of user activity, etc. For example, based on a query of “where should I put my books,” the method 400 includes determining, for the first feature property, a non-mobile object on which the books could be placed.

In some implementations, the method 400 includes determining a second feature property based on the query. For example, based on the first utterance 134 (“where is a good place to do yoga?”), the method 400 includes determining the second feature property corresponds to at least a medium luminance level, which is suitable for practicing yoga. As another example, the method 400 includes determining the second feature property corresponds to empty space, which is also suitable for practicing yoga.

As represented by block 408, the method 400 includes identifying a first volumetric region of the first plurality of volumetric regions based on determining that the first volumetric region satisfies a criterion with respect to the first feature property. For example, determining that the first volumetric region satisfies the criterion includes determining that the first volumetric region matches the first feature property within an error threshold. Continuing with the previous example and with reference to FIG. 1F, the method 400 includes identifying the fifth volumetric region 132 including the expanded empty space 131, because the fifth volumetric region 132 corresponds to at least six feet by three feet, and thus matches the first feature property within the error threshold. In some implementations, the first volumetric region matches the first feature property within the error threshold when dimensions (e.g., length, width, height) of the first volumetric region are sufficiently similar to dimensions of the first feature property. In some implementations, the first volumetric region matches the first feature property within the error threshold when the total volume of the volumetric region is sufficiently similar to the total volume of the first feature property.

In some implementations, determining that the first volumetric region matches the first feature property within the error threshold includes performing semantic analysis of the first volumetric region or of an area proximate to the first volumetric region. For example, the method 400 includes performing semantic segmentation on image data including the first volumetric region, to identify a “yoga mat” within the first volumetric region. Continuing with this example, the method 400 includes determining that the first volumetric region matches the first feature property within the error threshold, because the first feature property includes a soft ground requirement that is satisfied by the presence of the semantically identified “yoga mat.” As one example, the soft ground requirement is determined based on a query of “where is a suitable place to perform a physical activity?”

In some implementations, determining that the first volumetric region matches the first feature property within the error threshold includes determining that a threshold number of characteristics (e.g., at least two) associated with the first volumetric region are included in the first feature property. For example, the first volumetric region is associated with a first characteristic indicating a low luminance level, a second characteristic indicating a hard ground surface, and a third characteristic indicating that no sharp physical objects exist within or proximate to the first volumetric region. Continuing with this example, the first feature property includes a medium luminance, a hard ground surface, and no sharp physical objects. Continuing with this example, the method 400 includes determining that the first volumetric region matches the first feature property within the error threshold because at least two of the characteristics of the first volumetric region—hard ground surface and no sharp physical objects—are included in the first feature property.

In some implementations, the method 400 includes determining multiple feature properties for a single query, and determining the error threshold is satisfied when a threshold number of the feature properties matches corresponding characteristics of the first volumetric region. For example, based on a query of “where is a good place to practice yoga?” the method 400 includes determining a first set of feature properties including empty space, at least medium luminance, and a floor surface. Continuing with this example, the method 400 includes determining whether the first volumetric region is associated with characteristics that match a threshold number of the first set of feature properties, such as at least two of the three of the first set of feature properties—e.g., empty space and floor surface, but not medium luminance. As another example, based on a query of “where is a good place to eat dinner?” the method 400 includes determining a different, second set of feature properties including chair, table, and at least medium luminance. Continuing with this example, the method 400 includes determining whether the first volumetric region is associated with characteristics that match a threshold number of the second set of feature properties, such as at least two of the three of the second set of feature properties—e.g., chair and medium luminance, but not table.

As represented by block 410, in some implementations, identifying the first volumetric region is further based one or more characteristics associated with the first volumetric region. For example, identifying the first volumetric region includes determining that the characteristic(s) match the first feature property within the error threshold. To that end, in some implementations, the method 400 includes determining the characteristic(s) based on the first representation of the physical environment at the first time. For example, method 400 includes determining a characteristic of empty space associated with the first volumetric region. Referring back to the yoga example, the method 400 includes identifying the first volumetric region based on the empty space characteristic matching the feature property of empty space being suitable for practicing yoga. Non-limiting examples of characteristic(s) include space type (e.g., empty space), type of object in space (e.g., mobile object or non-mobile object), luminance level, type of user activity, etc. For example, the method 400 includes determining a characteristic of the first volumetric region corresponds to the empty space, based on determining that at least a threshold portion of the first volumetric region includes empty space.

In some implementations, each of a plurality of characteristics is associated with a corresponding portion of the first volumetric region. For example, with reference to FIGS. 1D and 3B, the method 400 includes determining multiple characteristics associated with the fifth volumetric region 132 (including the expanded empty space 131). Namely, the method 400 includes determining the seventh characteristic 360-1 of “high luminance” for the left portion of the expanded empty space 131, the eighth characteristic 360-2 of “medium luminance” for the middle portion of the expanded empty space 131, and the ninth characteristic 360-3 of “low luminance”for the right portion of the expanded empty space 131.

In some implementations, the method 400 includes updating a characteristic at different times, based on correspondingly different representations of the physical environment. For example, with reference to FIGS. 1B and 3A, the method 400 includes determining the second characteristic 304-2, indicating a “low luminance” associated with the first volumetric region 120 (including the physical window 110), because there is little sunlight entering the physical window 110 at 6:00 am. Continuing with this example, with reference to FIGS. 1D and 3B, the method 400 includes determining the updated second characteristic 304-3 associated with the first volumetric region 120, indicating “high luminance” for the physical window 110 at 11:00 am. As another example, the method 400 includes identifying the first volumetric region 120 at 11:00 am because the “high luminance” matches the second feature property of at least medium luminance levels within the error threshold. Moreover, the method 400 may include foregoing identifying the first volumetric region 120 at 6:00 am because the “low luminance” does not match the second feature property of at least medium luminance levels within the error threshold. Thus, as represented by block 412, in some implementations, identifying the first volumetric region includes determining that the first volumetric region also satisfies the criterion with respect to another feature property (the second feature property).

In some implementations, a first characteristic is of a first type, and a second characteristic is of a second type different from the first type. For example, the first type is luminance level, and the second type is space type (e.g., open space versus object).

As represented by block 414, in some implementations, the method 400 includes presenting, on a display, an indicator at a location corresponding to the first volumetric region of the physical environment. For example, with reference to FIG. 1F, the electronic device 104 displays the first indicator, including the text 136 indicating “Here is a good spot for yoga. Open and sunny,” the arrow 138 leading from the text 136, and the ovular location indicator 140 showing where it is suitable to practice yoga. In some implementations, the indicator includes information regarding the query, such as the text 136 including “yoga,” which is part of the first utterance 134 of “where is a good place to do yoga?”

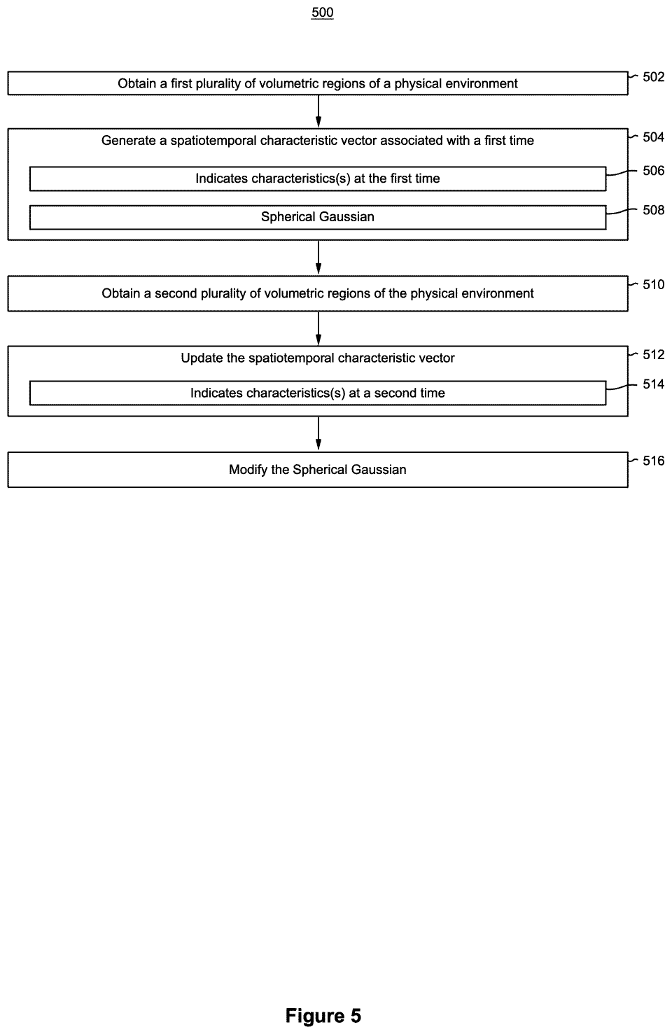

FIG. 5 is an example of a flow diagram of a method 500 of generating and updating a spatiotemporal characteristic vector associated with a physical environment at different times in accordance with some implementations. In various implementations, the method 500 or portions thereof are performed by an electronic device including one or more processors and a non-transitory memory. For example, the electronic device 104 described with reference to FIGS. 1A-1H or the electronic device 200 described with reference to FIG. 2 performs the method 500. In various implementations, the method 500 or portions thereof are performed by a head-mountable device (HMD). In some implementations, the method 500 is performed by processing logic, including hardware, firmware, software, or a combination thereof. In some implementations, the method 500 is performed by a processor executing code stored in a non-transitory computer-readable medium (e.g., a memory). In various implementations, some operations in method 500 are, optionally, combined and/or the order of some operations is, optionally, changed.

As represented by block 502, the method 500 includes obtaining a first plurality of volumetric regions of a physical environment, based on a first representation of the physical environment at a first time. For example, obtaining the first plurality of volumetric regions is described with reference to blocks 402 and 404.

As represented by block 504, in some implementations, the method 500 includes generating, based on the first representation of the physical environment at the first time, a spatiotemporal characteristic vector. The spatiotemporal characteristic vector indicates the physical environment is characterized by the first plurality of volumetric regions at the first time. For example, with reference to FIG. 3A, the spatiotemporal characteristic vector corresponds to the first spatiotemporal characteristic vector 300. The first spatiotemporal characteristic vector 300 includes a first temporal value 302, indicating the first time of “6:00 am” illustrated in FIGS. 1A and 1B. Moreover, the first spatiotemporal characteristic vector 300 includes the first volumetric region indicator 304 indicative of the first volumetric region 120 (including the physical window 110), the second volumetric region indicator 310 indicative of the second volumetric region 122 (including the individual 112), the third volumetric region indicator 320 indicative of the third volumetric region 124 (including the empty space 114), and the fourth volumetric region indicator 330 indicative of the fourth volumetric region 126 (including the physical table 108).

As represented by block 506, in some implementations, the spatiotemporal characteristic vector includes one or more characteristics associated with one or more of the first plurality of volumetric regions. For example, with reference to FIG. 3A, the first spatiotemporal characteristic vector 300 includes a first characteristic 304-1 of “window” and a second characteristic 304-2 of “low luminance,” both of which are associated with the first volumetric region 120 (including the physical window 110). Thus, in some implementations, the spatiotemporal characteristic vector includes a first characteristic of a first type (type of object=“window”), and a second characteristic of a second type (luminance level=“low luminance”) that is different from the first type.

As represented by block 508, in some implementations, the spatiotemporal characteristic vector is represented by a spherical gaussian that defines respective relationships between a plurality of characteristics and the corresponding portions of the first volumetric region. For example, with reference to FIG. 1D, a spherical gaussian is associated with the fifth volumetric region 132 (including the expanded empty space 131). Continuing with this example, the spherical gaussian indicates a first characteristic of high luminance for the left portion of the fifth volumetric region 132, a second characteristic of medium luminance for the middle portion of the fifth volumetric region 132, and a third characteristic of low luminance for the right portion of the fifth volumetric region 132.

As represented by block 510, in some implementations, the method 500 includes obtaining a second plurality of volumetric regions of the physical environment, based on a second representation of the physical environment at a second time. The second time is different from the first time. For example, the first time corresponds to 6:00 am as illustrated in FIGS. 1A and 1B, and the second time corresponds to 11:00 am as illustrated in FIGS. 1C-1H. As one example, the second representation of the physical environment at the second time corresponds to a 3D mesh of the operating environment 100 at 11:00 am.

As represented by block 512, in some implementations, the method 500 includes updating the spatiotemporal characteristic vector based on the second plurality of volumetric regions. For example, with reference to FIG. 3B, updating the spatiotemporal characteristic vector includes determining the second spatiotemporal characteristic vector 340. The second spatiotemporal characteristic vector 340 is associated with the second time, as indicated by the second temporal value 350 of 11:00 am. Continuing with this example, because the individual 112 is no longer within the operating environment 100 at 11:00 am, the second spatiotemporal characteristic vector 340 no longer includes the second volumetric region indicator 310 associated with the individual 112. On the other hand, because of the sun rays 128 present at the second time that were not present at the first time, the second spatiotemporal characteristic vector 340 includes various luminance characteristics indicative of medium and high levels of luminance associated with corresponding volumetric regions. Thus, as represented by block 514, the updated spatiotemporal characteristic vector may be indicative of characteristics of volumetric regions at the second time.

As represented by block 516, in some implementations, the method 500 includes modifying the spherical gaussian based on the second representation of the physical environment. For example, modifying the spherical gaussian includes resizing the spherical gaussian. As one example, resizing corresponds to expanding or shrinking the spherical gaussian. For example, a spherical gaussian associated with the empty space 114 at the first time in FIG. 1B is expanded to account for the expanded empty space 131 at the second time in FIG. 1C. Resizing may include cancelling a spherical gaussian. For example, a spherical gaussian is associated with the individual 112 at the time in FIG. 1B, but the individual 112 is not present in the operating environment 100 at the second time in FIG. 1C. Based on the absence of the individual 112, the method 500 includes cancelling the spherical gaussian.

In some implementations, a spherical gaussian is modified to define respective relationships between a second plurality of characteristics and corresponding portions of the first volumetric region. To that end, in some implementations, the method 500 includes determining a second plurality of characteristics of the first volumetric region at the second time based on the second representation of the physical environment. The first plurality of characteristics is different from the second plurality of characteristics. For example, at the first time a spherical gaussian defines that a physical object is associated with a low luminance level, and the spherical gaussian is modified to define that at the second time the physical object is associated with a high luminance level. Thus, in some implementations, modifying a spherical gaussian does not include resizing the spherical gaussian, but rather modifying characteristics that the spherical gaussian defines.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user's personal information. For example, such personal information may be utilized in order to provide an improved privacy screen on an electronic device. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at a device including one or more processors and a non-transitory memory:
obtaining a first plurality of volumetric regions of a physical environment based on a first representation of the physical environment at a first time, wherein each of the first plurality of volumetric regions includes a corresponding portion of the physical environment;
determining a first feature property based on a query; and
identifying a first volumetric region of the first plurality of volumetric regions based on determining that the first volumetric region satisfies a criterion with respect to the first feature property.

2. The method of claim 1, wherein determining that the first volumetric region satisfies the criterion includes determining that the first volumetric region matches the first feature property within an error threshold.

3. The method of claim 1, further comprising determining a second feature property based on the query, wherein the first feature property is different from the second feature property, and wherein identifying the first volumetric region includes determining that the first volumetric region satisfies the criterion with respect to the second feature property.

4. The method of claim 1, wherein the first feature property is associated with the first volumetric region, the method further comprising:
determining, for a second volumetric region of the first plurality of volumetric regions, a second feature property based on the query; and
assessing the first feature property and the second feature property to identify the first volumetric region and forego identifying the second volumetric region.

5. The method of claim 1, further comprising generating, based on the first representation of the physical environment at the first time, a spatiotemporal characteristic vector, wherein the spatiotemporal characteristic vector indicates the physical environment is characterized by the first plurality of volumetric regions at the first time.

6. The method of claim 5, further comprising:
obtaining a second plurality of volumetric regions of the physical environment based on a second representation of the physical environment at a second time; and
updating the spatiotemporal characteristic vector to indicate the physical environment is characterized by the second plurality of volumetric regions at the second time.

7. The method of claim 6, wherein updating the spatiotemporal characteristic vector includes removing a subset of the first plurality of volumetric regions that is not included in the second plurality of volumetric regions.

8. The method of claim 5, wherein the spatiotemporal characteristic vector indicates a first characteristic associated with the first volumetric region at the first time, and wherein identifying the first volumetric region further includes determining that first characteristic matches the first feature property within an error threshold.

9. The method of claim 8, wherein the spatiotemporal characteristic vector indicates a second characteristic associated with the first volumetric region at the first time different, wherein the second characteristic is different from the first characteristic, and wherein identifying the first volumetric region includes determining that second characteristic matches the first feature property within the error threshold.

10. The method of claim 9, wherein the first characteristic is of a first type, and wherein the second characteristic is of a second type different from the first type.

11. The method of claim 8, wherein the first characteristic corresponds to empty space.

12. The method of claim 11, further comprising determining the first characteristic corresponds to the empty space based on determining that at least a threshold portion of the first volumetric region includes empty space.

13. The method of claim 5, wherein the spatiotemporal characteristic vector includes a first plurality of characteristics, and wherein each of the first plurality of characteristics is associated with a corresponding portion of the first volumetric region.

14. The method of claim 13, wherein the spatiotemporal characteristic vector is represented by a spherical gaussian that defines respective relationships between the first plurality of characteristics and the corresponding portions of the first volumetric region.

15. The method of claim 14, further comprising:
obtaining a second representation of the physical environment at a second time; and
modifying the spherical gaussian based on the second representation of the physical environment.

16. The method of claim 15, further comprising:
determining a second plurality of characteristics of the first volumetric region at the second time based on the second representation of the physical environment, wherein the first plurality of characteristics is different from the second plurality of characteristics; and
modifying the spherical gaussian to define respective relationships between the second plurality of characteristics and corresponding portions of the first volumetric region.

17. The method of claim 1, further comprising presenting, on a display, an indicator at a location corresponding to the first volumetric region of the physical environment.

18. The method of claim 17, wherein the indicator includes information regarding the query.

19. An electronic device comprising:
one or more processors;
a non-transitory memory; and
one or more programs, wherein the one or more programs are stored in the non-transitory memory and configured to be executed by the one or more processors, the one or more programs including instructions for:
obtaining a first plurality of volumetric regions of a physical environment based on a first representation of the physical environment at a first time, wherein each of the first plurality of volumetric regions includes a corresponding portion of the physical environment;
determining a first feature property based on a query; and
identifying a first volumetric region of the first plurality of volumetric regions based on determining that the first volumetric region satisfies a criterion with respect to the first feature property.

20. A non-transitory computer readable storage medium storing one or more programs, the one or more programs comprising instructions, which, when executed by an electronic device with one or more processors, cause the electronic device to:
obtain a first plurality of volumetric regions of a physical environment based on a first representation of the physical environment at a first time, wherein each of the first plurality of volumetric regions includes a corresponding portion of the physical environment;
determine a first feature property based on a query; and
identify a first volumetric region of the first plurality of volumetric regions based on determining that the first volumetric region satisfies a criterion with respect to the first feature property.
